(19) United States
(12) Patent Application Publication
(10) Pub. No.: US 2013/0321572 A1
(43) Pub. Date: Dec. 5, 2013

(54) METHOD AND APPARATUS FOR REFERRING TO DISPARITY RANGE SETTING TO SEPARATE AT LEAST A PORTION OF 3D IMAGE DATA FROM AUXILIARY GRAPHICAL DATA IN DISPARITY DOMAIN

(71) Applicants: Cheng-Tsai Ho, Taichung City (TW); Ding-Yun Chen, Taipei City (TW); Chi-Cheng Ju, Hsinchu City (TW)

(72) Inventors: Cheng-Tsai Ho, Taichung City (TW); Ding-Yun Chen, Taipei City (TW); Chi-Cheng Ju, Hsinchu City (TW)

(21) Appl. No.: 13/485,858

(22) Filed: May 31, 2012

(51) Int. Cl. H04N 13/00

(52) U.S. Cl. 348/43; 348/E13.067; 348/E13.062

(57) ABSTRACT

An image processing method includes: receiving a disparity range setting which defines a target disparity range; receiving 3D image data with original disparity not fully within the target disparity range; receiving auxiliary graphical data with original disparity fully beyond the target disparity range; and generating modified 3D image data, including at least a modified portion with modified disparity fully within the target disparity range, by modifying at least a portion of the received 3D image data according to the obtained disparity range setting. At least the modified portion of the modified 3D image data is derived from at least the portion of the received 3D image data that has disparity overlapped with disparity of the received auxiliary graphical data. With the help of the disparity modification, the playback of the 3D image data may be protected from being obstructed by the display of the auxiliary graphical data.

### BACKGROUND

The disclosed embodiments of the present invention relate to processing a three-dimensional (3D) image data and an auxiliary graphical data, and more particularly, to a method and apparatus for referring to a disparity range setting to separate at least a portion (e.g., part or all) of a 3D image data from an auxiliary graphical data in a disparity domain.

Video playback devices for controlling playback of a two-dimensional (2D) video/image data are known. The video playback device is generally coupled to a 2D display apparatus such as a television or monitor. The 2D video/image data is transferred from the video playback device to the 2D display apparatus for presenting the 2D video/image content to the user. In addition to the 2D video/image content, the video playback device may also drive the 2D display apparatus to display auxiliary graphical data, such as a subtitle, a graphical user interface (GUI), an on-screen display (OSD), or a logo.

Currently, video playback devices for controlling playback of a three-dimensional (3D) video/image data are proposed. In addition, 3D display apparatuses for presenting 3D video/image contents to the user are proposed. Similarly, the 3D display apparatus may also display the 3D video/image content in combination with the auxiliary graphical data (e.g., subtitle, GUI, OSD, or logo). In general, disparity is referenced as coordinate differences of the same point between the right-eye image and left-eye image, and the disparity is usually measured in pixels. Therefore, when disparity of the auxiliary graphical data is overlapped with disparity of the 3D video/image data, the display of the auxiliary graphical data would obstructs 3D effects presented by playback of the 3D video/image data.

Thus, there is a need for an innovative design which is capable of preventing the playback of the 3D video/image data from being obstructed by the display of the auxiliary graphical data.

### SUMMARY

In accordance with exemplary embodiments of the present invention, a method and apparatus for referring to a disparity range setting to separate at least a portion (e.g., part or all) of a 3D image data from an auxiliary graphical data in a disparity domain are proposed to solve the above-mentioned problems.

According to a first aspect of the present invention, an exemplary image processing method is disclosed. The exemplary image processing method includes the following steps: receiving a disparity range setting which defines a target disparity range; receiving a three-dimensional (3D) image data with original disparity not fully within the target disparity range; receiving an auxiliary graphical data with original disparity fully beyond the target disparity range; and generating a modified 3D image data including at least a modified portion with modified disparity fully within the target disparity range by modifying at least a portion of the received 3D image data according to the obtained disparity range setting. At least the modified portion of the modified 3D image data is derived from at least the portion of the received 3D image data that has disparity overlapped with disparity of the received auxiliary graphical data.

According to a second aspect of the present invention, an exemplary image processing method is disclosed. The exemplary image processing method includes the following steps: receiving a disparity range setting which defines a target disparity range; receiving a three-dimensional (3D) image data with original disparity not fully within the target disparity range; receiving an auxiliary graphical data with disparity not fully beyond the target disparity range; generating a modified 3D image data including at least a modified portion with modified disparity fully within the target disparity range by modifying at least a portion of the received 3D image data according to the obtained disparity range setting; and generating a modified auxiliary graphical data with modified disparity fully beyond the target disparity range by modifying the received auxiliary graphical data according to the disparity range setting. At least the modified portion of the modified 3D image data is derived from at least the portion of the received 3D image data that has disparity overlapped with disparity of the received auxiliary graphical data.

According to a third aspect of the present invention, an exemplary image processing apparatus is disclosed. The exemplary image processing apparatus includes a receiving circuit and a processing circuit. The receiving circuit is arranged for receiving a disparity range setting which defines a target disparity range, receiving a three-dimensional (3D) image data with original disparity not fully within the target disparity range, and receiving an auxiliary graphical data with original disparity fully beyond the target disparity range. The processing circuit is coupled to the receiving circuit, and arranged for generating a modified 3D image data including at least a modified portion with modified disparity fully within the target disparity range by modifying at least a portion of the received 3D image data according to the obtained disparity range setting. At least the modified portion of the modified 3D image data is derived from at least the portion of the received 3D image data that has disparity overlapped with disparity of the received auxiliary graphical data.

According to a fourth aspect of the present invention, an exemplary image processing apparatus is disclosed. The exemplary image processing apparatus includes a receiving circuit and a processing circuit. The receiving circuit is arranged for receiving a disparity range setting which defines a target disparity range, receiving a three-dimensional (3D) image data with original disparity not fully within the target disparity range, and receiving an auxiliary graphical data with disparity not fully beyond the target disparity range. The processing circuit is coupled to the receiving circuit, and arranged for generating a modified 3D image data including at least a modified portion with modified disparity fully within the target disparity range by modifying at least a portion of the received 3D image data according to the obtained disparity range setting, and generating a modified auxiliary graphical data with modified disparity fully beyond the target disparity range by modifying the received auxiliary graphical data according to the disparity range setting. At least the modified portion of the modified 3D image data is derived from at least the portion of the received 3D image data that has disparity overlapped with disparity of the received auxiliary graphical data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image processing apparatus according to a first exemplary embodiment of the present invention.

FIG. 2 is a flowchart illustrating a method of performing disparity modification upon the 3D image data to generate the modified 3D image data according to an embodiment of the present invention.

FIG. 3 is a diagram illustrating the relationship between the original disparity range of the 3D image data and the target disparity range.

FIG. 4 is a diagram illustrating the relationship between the modified disparity range of the modified 3D image data and the target disparity range when a linear mapping scheme is employed.

FIG. 5 is a diagram illustrating the relationship between the modified disparity range of the modified 3D image data and the target disparity range when a nonlinear mapping scheme is employed.

FIG. 6 is a diagram illustrating that a user perceives 2D graphical data's content displayed in front of 3D image data's content.

FIG. 7 is a diagram illustrating that a user perceives 3D graphical data's content displayed in front of 3D image data's content.

FIG. 8 is a diagram illustrating the relationship among the original disparity range of the 3D image data, the target disparity range, and the original disparity of the auxiliary graphical data.

FIG. 9 is a diagram illustrating the relationship among the modified disparity range of the modified 3D image data, the target disparity range, and the modified disparity of the modified auxiliary graphical data.

FIG. 10 is a diagram illustrating that a user perceives auxiliary graphical data's content displayed in front of 3D image data's content.

FIG. 11 is a flowchart illustrating a method of performing disparity modification upon the auxiliary graphical image data to generate the modified auxiliary graphical data according to an exemplary embodiment of the present invention.

FIG. 12 is a diagram illustrating the relationship among the original disparity range of the 3D image data, the target disparity range, and the original disparity range of the auxiliary graphical data.

FIG. 13 is a diagram illustrating the relationship among the modified disparity range of the modified 3D image data, the target disparity range, and the modified disparity range of the modified auxiliary graphical data.

FIG. 14 is a block diagram illustrating an image processing apparatus according to a second exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The main concept of the present invention is to at least adjust the disparity of at least a portion (e.g., part or all) of the 3D image data for separating at least the portion of the 3D image data from the auxiliary graphical data (e.g., subtitle, GUI, OSD, or logo) in a disparity domain. It should be noted that the auxiliary graphical data is generally displayed in a small area of the whole screen/image. Thus, only part of display of the 3D image data may be actually overlapped with display of the auxiliary graphical data. One exemplary design of the present invention may adjust disparity of all of the 3D image data for achieving the objective of separating the overlapped part of the 3D image data (whose disparity is overlapped with the disparity of the auxiliary graphical data) from the auxiliary graphical data in the disparity domain. Another exemplary design of the present invention may merely adjust disparity of part of the 3D image data for achieving the same objective of separating the overlapped part of the 3D image data (whose disparity is originally overlapped with the disparity of the auxiliary graphical data) from the auxiliary graphical data in the disparity domain. In this way, as the disparity of at least the portion of the 3D image data is not overlapped with the disparity of the auxiliary graphical data, the playback of the 3D image data is therefore protected from being obstructed by the display of the auxiliary graphical data. In addition, no complicated computation is required by the proposed disparity modification technique, thus simplifying the hardware design and reducing the production cost. Further details are described as follows.

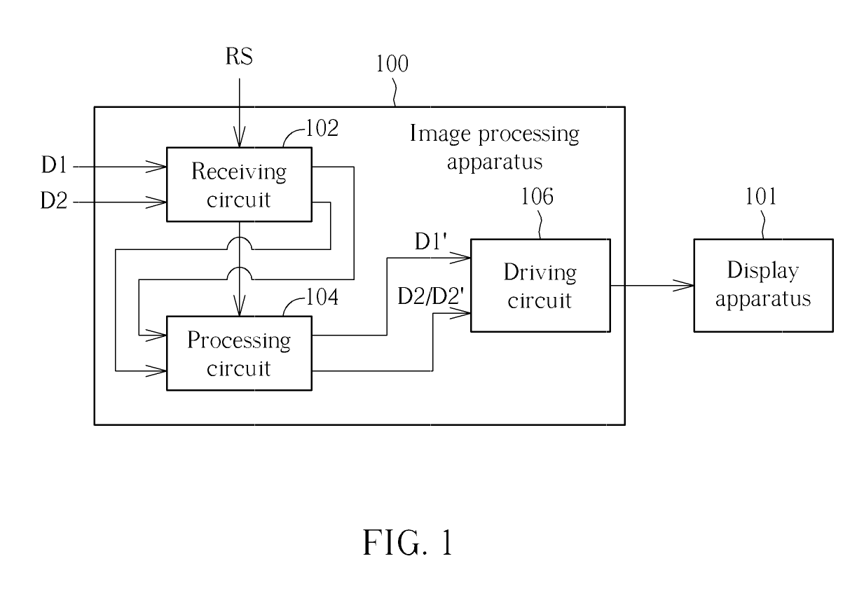

FIG. 1 is a block diagram illustrating an image processing apparatus according to a first exemplary embodiment of the present invention. By way of example, but not limitation, the exemplary image processing apparatus 100 may be disposed in a video player for controlling playback of the received video/image data. As shown in FIG. 1, the exemplary image processing apparatus 100 includes, but is not limited to, a receiving circuit 102, a processing circuit 104, and a driving circuit 106, where the processing circuit 104 is coupled between the receiving circuit 102 and the driving circuit 106. The receiving circuit 102 is arranged for receiving a disparity range setting RS, a three-dimensional (3D) image data D1, and an auxiliary graphical data D2. The disparity range setting RS may be derived from a user input or a default setting, and defines a target disparity range R_target. The 3D image data D1 and the auxiliary graphical data D2 are separately provided by a preceding stage. In one embodiment, the preceding stage may be a data source which stores both of the 3D image data D1 and the auxiliary graphical data D2. In another embodiment, the preceding stage may be a pre-processing circuit which receives a single data stream having the 3D image data D1 and the auxiliary graphical data D2 integrated therein (e.g., the subtitle is part of each image frame), extracts the auxiliary graphical data D2 from the data stream, and obtain the 3D image data D1 by removing the auxiliary graphical data D2 from the data stream. In other words, the present invention has no limitation on the source of the 3D image data D1 and the auxiliary graphical data D2.

The image processing apparatus 100 may operate under one of a first operational scenario and a second operational scenario. Regarding the first operational scenario, the 3D image data D1 with original disparity not fully within the target disparity range R_target and the auxiliary graphical data D2 with original disparity fully beyond the target disparity range R_target are received by the receiving circuit 102. Next, the processing circuit 104 is operative to generate a modified 3D image data D1′, which includes at least a modified portion (e.g., part or all of the modified 3D image data D1′) with modified disparity fully within the target disparity range R_target, by modifying at least a portion (e.g., part or all) of the received 3D image data D1 according to the disparity range setting RS, and directly bypass the received auxiliary graphical data D2 without any disparity modification applied thereto. Specifically, at least the portion of the received 3D image data D1 has disparity overlapped with disparity of the received auxiliary graphical data D2. The disparity modification applied to the 3D image data D1 by the processing circuit 104 is detailed as below.

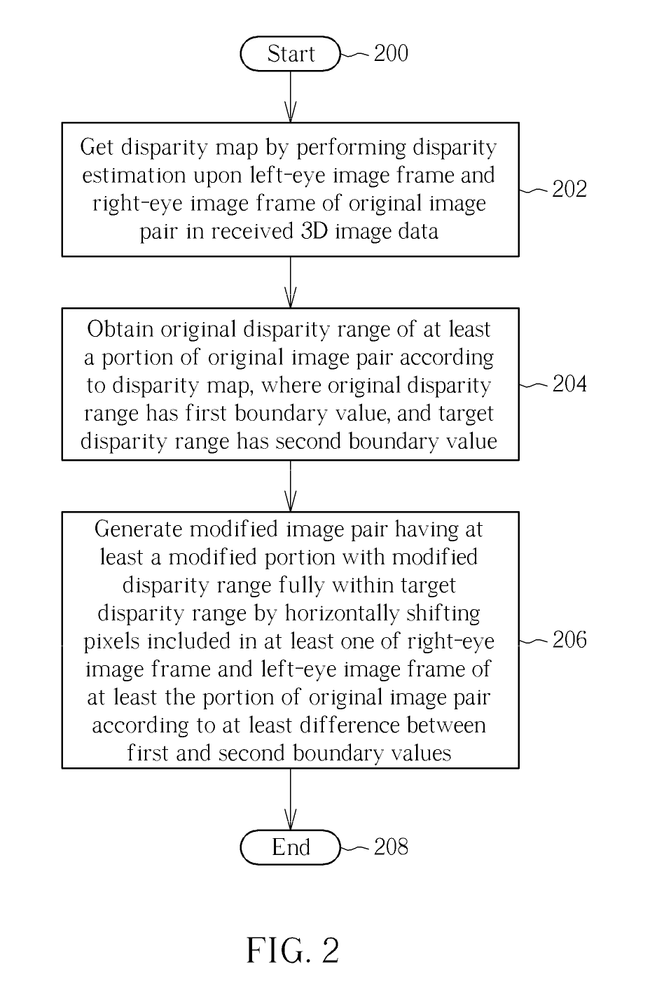

Please refer to FIG. 2, which is a flowchart illustrating a method of performing disparity modification upon the 3D image data D1 to generate the modified 3D image data D1′ according to an embodiment of the present invention. Provided that the result is substantially the same, the steps are not required to be executed in the exact order shown in FIG. 2. Suppose that the received 3D image data includes at least one image pair each having a right-eye image frame and a left-eye image frame. The disparity modification applied to an original image pair having one right-eye image frame and one left-eye image frame for generating a corresponding modified image pair may include following steps.

Step 200: Start.

Step 202: Get a disparity map by performing disparity estimation upon the left-eye image frame and the right-eye image frame of the original image pair in the received 3D image data D1.

Step 204: Obtain an original disparity range R_original of at least a portion (e.g., part or all) of the original image pair according to the disparity map, where the original disparity range R_original has a boundary value V11, and the target disparity range R_target has a boundary value V21. In a case where the exemplary disparity modification is to be applied to all of the 3D image data, the obtained original disparity range R_original is a disparity range of the full original image pair. In another case where the exemplary disparity modification is to be applied to part of the 3D image data, the original disparity range R_original is a disparity range of the partial original image pair with disparity overlapped with disparity of the auxiliary graphical data.

Step 206: Generate the modified image pair having at least a modified portion (e.g., part or all of the modified image pair) with a modified disparity range R_mod fully within the target disparity range R_target by horizontally shifting pixels included in at least one of the right-eye image frame and the left-eye image frame of at least the portion of the original image pair according to at least the difference DIFF between the boundary values V11 and V21. In a case where the exemplary disparity modification is applied to all of the 3D image data, pixels included in at least one of the right-eye image frame and the left-eye image frame of the full original image pair are horizontally shifted for adjusting the disparity range of the full original image pair. In another case where the exemplary disparity modification is to be applied to part of the 3D image data, only pixels included in at least one of the right-eye image frame and the left-eye image frame of the partial original image pair are horizontally shifted for merely adjusting the disparity range of the partial original image pair with disparity overlapped with the auxiliary graphical data.

Step 208: End.

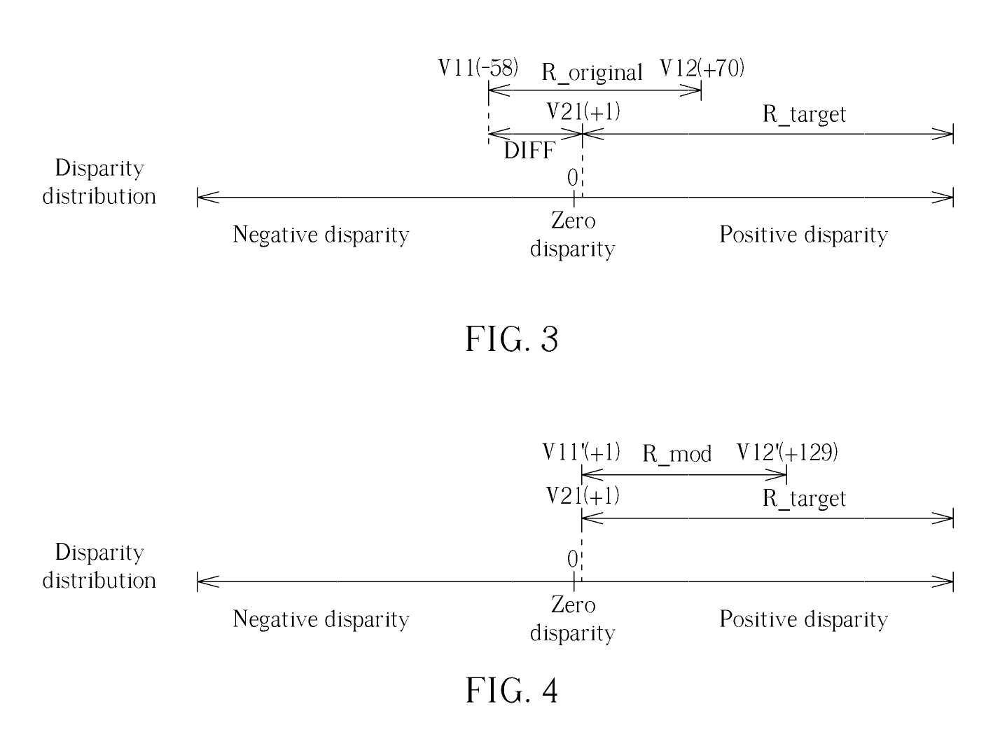

For clarity and simplicity, assume that the exemplary disparity modification mentioned hereinafter is applied to all of the 3D image data for preventing the playback of the 3D video/image data from being obstructed by the display of the auxiliary graphical data. The disparity map generated in step 202 includes disparity values associated with the original image pair, where each disparity value is referenced as a coordinate difference of the same point between one right-eye image frame and one left-eye image frame, and the coordinate difference is usually measured in pixels. Hence, based on the disparity values given by the disparity map, the original disparity range R_original of the original image pair is easily obtained. FIG. 3 is a diagram illustrating the relationship between the original disparity range R_original of the 3D image data D1 and the target disparity range R_target. In this example, the aforementioned boundary value V11 is a lower bound of the original disparity range R_original, and the aforementioned boundary value V21 is a lower bound of the target disparity range R_target. As can be seen from FIG. 3, the original disparity range R_original is delimited by the lower bound V11 and an upper bound V12. For example, the lower bound V11 is equal to −58, and the upper bound V12 is equal to +70. This also implies that the smallest disparity possessed by the original image pair is −58, and the largest disparity possessed by the original image pair is +70.

As can be seen from FIG. 3, the original disparity range R_original should be shifted horizontally right to fall within the target disparity range R_target. That is, all of the disparity values possessed by the original image pair should be increased. In this example, the difference DIFF between the boundary values V11 and V21 is +59 (i.e., V21-V11=+1−(−58)). When a linear mapping scheme is employed for performing the disparity modification, all pixels in the left-eye image frame may be shifted horizontally left by at least 59 pixels, while the right-eye image frame remains intact. In one alternative design, all pixels in the right-eye image frame may be shifted horizontally right by at least 59 pixels, while the left-eye image frame remains intact. In another alternative design, all pixels in the left-eye image frame may be shifted horizontally left by at least M pixels, and all pixels in the right-eye image frame may be shifted horizontally right by at least N pixels, where M+N=59. In other words, the linear mapping scheme would make the size of the modified disparity range R_mod of the modified image pair equal to the size of the original disparity range R_original of the original image pair. FIG. 4 is a diagram illustrating the relationship between the modified disparity range R_mod of the modified 3D image data D1′ and the target disparity range R_target when the linear mapping scheme is employed. As can be seen from FIG. 4, the modified disparity range R_mod is delimited by the lower bound V11′ and the upper bound V12′, where V11′ is equal to +1 (i.e., −58+59) and V12′ is equal to +129 (i.e., 70+59). Hence, the modified disparity range R_mod is fully within the target disparity range R_target now. It should be noted that aligning the lower bound V11′ of the modified disparity range R_mod with the lower bound V21 of the target disparity range R_target is merely one feasible implementation, and is not meant to be a limitation of the present invention.

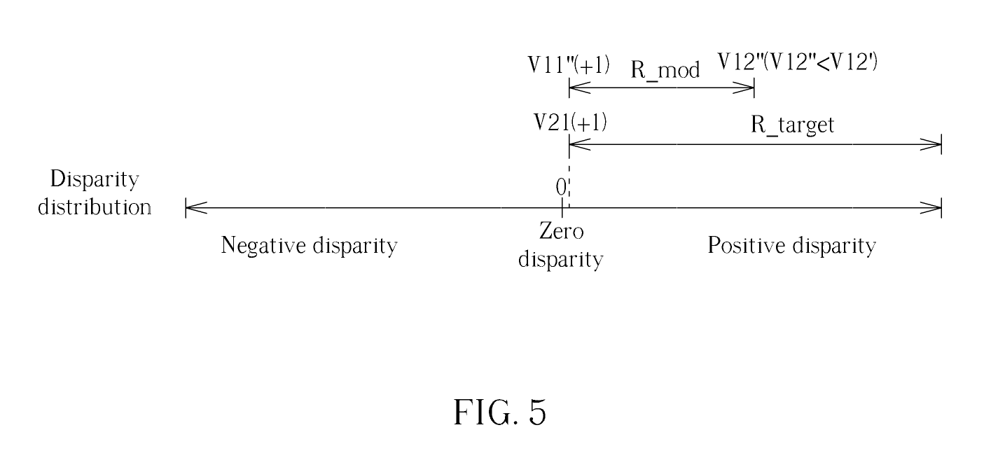

Besides, the implementation of the disparity modification is not limited to linear mapping. For example, a nonlinear mapping scheme may be employed for performing the required disparity modification. FIG. 5 is a diagram illustrating the relationship between the modified disparity range R_mod of the modified 3D image data D1′ and the target disparity range R_target when the nonlinear mapping scheme is employed. The modified disparity range R_mod is delimited by a lower bound V11″ and an upper bound V12″, where V11″ is equal to V21, and V12″ is smaller than V12′. In other words, the nonlinear mapping scheme would make the size of the modified disparity range R_mod of the modified image pair different from the size of the original disparity range R_original of the original image pair. The same objective of generating the modified 3D image data D1′ with modified disparity range R_mod fully within the target disparity range R_target is achieved. Similarly, aligning the lower bound V11″ of the modified disparity range R_mod with the lower bound V21 of the target disparity range R_target is merely one feasible implementation, and is not meant to be a limitation of the present invention.

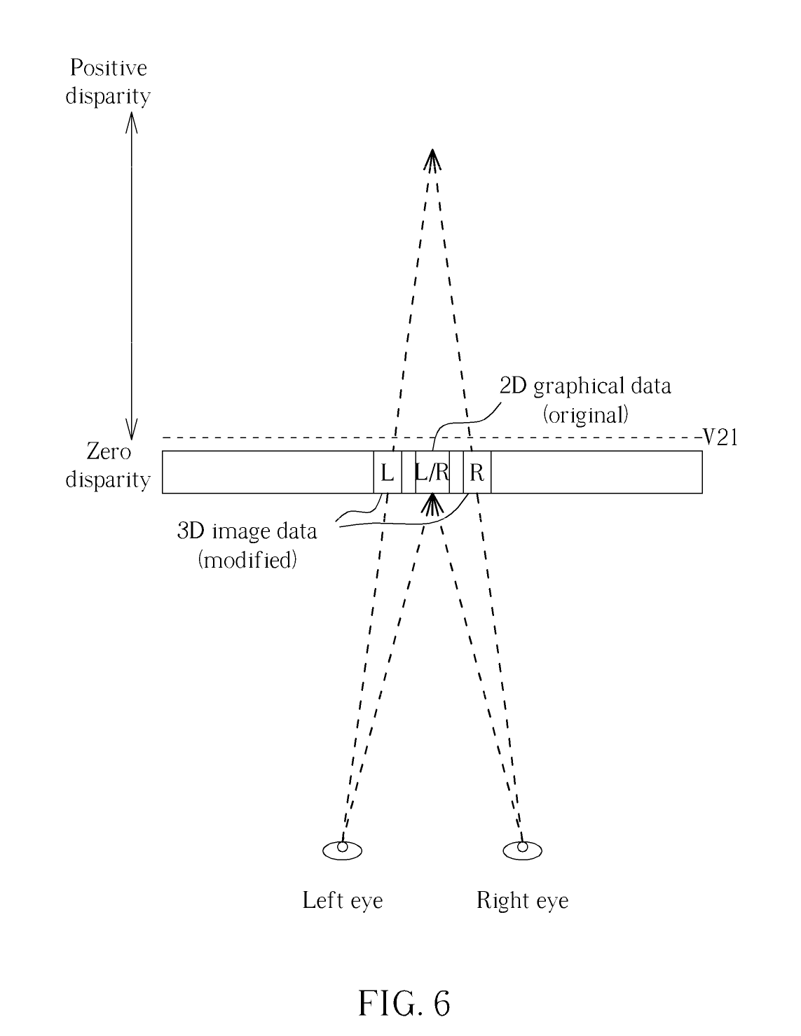

When the auxiliary graphical data D2 is a 2D graphical data (e.g., 2D subtitle), the auxiliary graphical data D2 would have zero disparity outside the target disparity range R_target. Besides, the original disparity of the auxiliary graphical data D2 is smaller than the modified disparity of the modified 3D image data D1′. As can be readily seen from FIG. 4/FIG. 5, the display of the 2D graphical data (i.e., the auxiliary graphical data D2) does not affect the 3D effect provided by the playback of the modified 3D image data D1′ due to the fact that the disparity range (e.g., zero disparity) of the auxiliary graphical data D2 is not overlapped with the modified disparity range (e.g., positive disparity) of the modified 3D image data D1′. Therefore, when the driving circuit 106 drives the display apparatus 101 to display the modified 3D image data D1′ and the auxiliary graphical data D2 with respective disparity settings, the user would always perceive 2D graphical data's content at a specific fixed depth where a display screen is located, and perceive 3D image data's content at different depths each being greater than the specific fixed depth. In other words, the user would always perceive 2D graphical data's content displayed in front of 3D image data's content, as shown in FIG. 6.

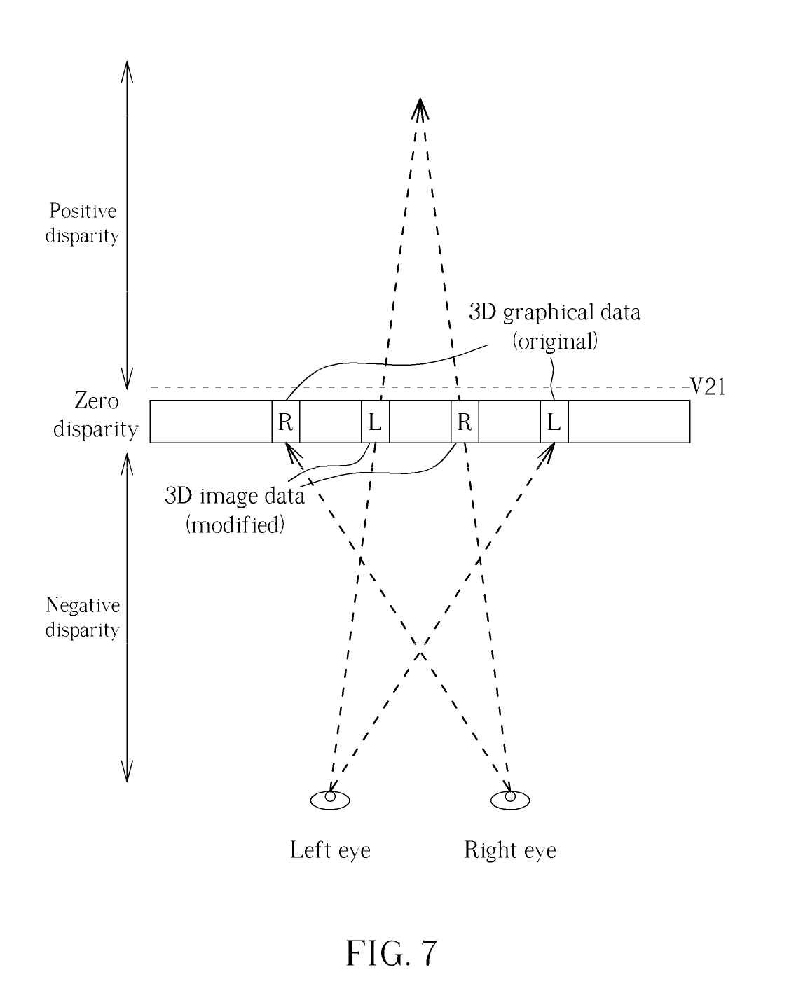

Alternatively, when the auxiliary graphical data D2 is a 3D graphical data (e.g., 3D subtitle), the auxiliary graphical data D2 may have disparity (e.g., negative disparity) fully beyond the target disparity range R_target. Similarly, as can be readily seen from FIG. 4/FIG. 5, the display of the 3D graphical data (i.e., the auxiliary graphical data D2) does not affect the 3D effect provided by the playback of the modified 3D image data D1′ due to the fact that the disparity range (e.g., negative disparity) of the auxiliary graphical data D2 is not overlapped with the disparity range (e.g., positive disparity) of the modified 3D image data D1′. Therefore, when the driving circuit 106 drives the display apparatus 101 to display the modified 3D image data D1′ and the auxiliary graphical data D2 with respective disparity settings, the user would always perceive 3D graphical data's content displayed in front of 3D image data's content, as shown in FIG. 7.

Regarding the first operational scenario, the exemplary disparity modification may be applied to part of the 3D image data rather than all of the 3D image data. In this alternative design, step 204 is executed to determine the original disparity range R_original by a disparity range of the partial original image pair with disparity overlapped with disparity of the auxiliary graphical data, and step 206 is executed to horizontally shift pixels included in at least one of the right-eye image frame and the left-eye image frame of the partial original image pair for only adjusting the disparity range of the partial original image pair with disparity overlapped with the auxiliary graphical data. As a person skilled in the art can readily understand operation of the exemplary disparity modification applied to part of the 3D image data after reading above paragraphs directed to the exemplary disparity modification applied to all of the 3D image data, further description is omitted here for brevity.

Regarding the second operational scenario, the receiving circuit 102 receives the 3D image data D1 with original disparity not fully within the target disparity range R_target and the auxiliary graphical data D2 with original disparity not fully beyond the target disparity range R_target. The processing circuit 104 is therefore operative to generate the modified 3D image data D1′, which includes at least a modified portion (e.g., part or all of the modified 3D image data D1′) with modified disparity fully within the target disparity range R_target, by modifying at least a portion (e.g., part or all) of the received 3D image data D1 according to the obtained disparity range setting RS, and generate a modified auxiliary graphical data D2′ with modified disparity fully beyond the target disparity range R_target by modifying the received auxiliary graphical data D2 according to the disparity range setting RS. Specifically, at least the portion of the received 3D image data D1 has disparity overlapped with disparity of the received auxiliary graphical data D2.

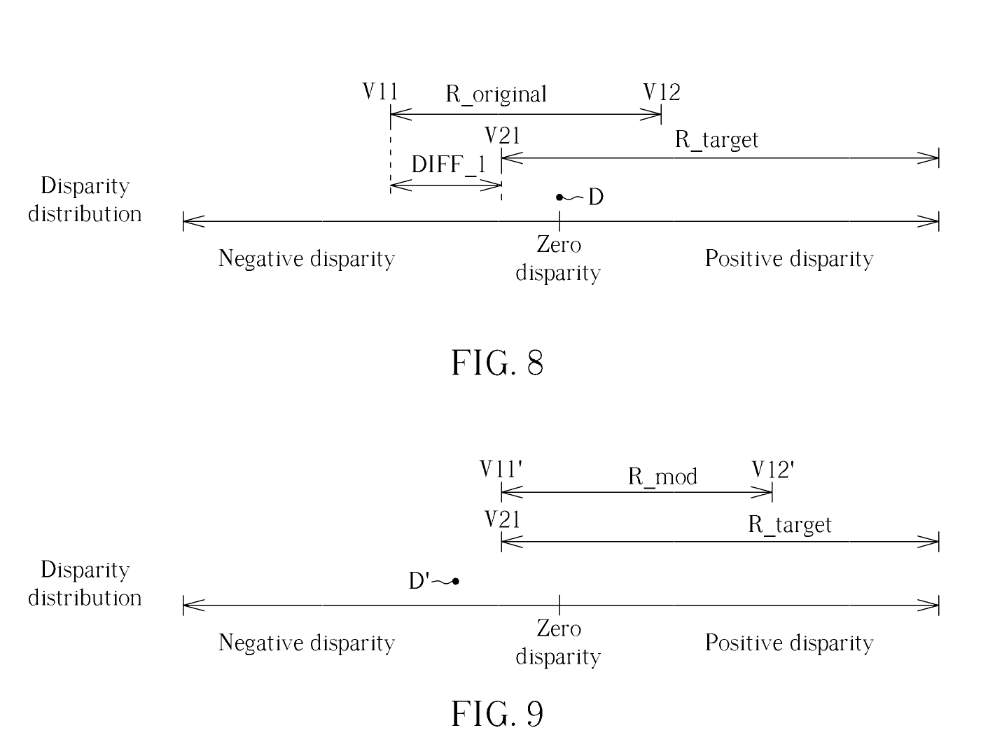

For clarity and simplicity, suppose that all of the 3D image data is adjusted by the exemplary disparity modification to thereby prevent the playback of the 3D video/image data from being obstructed by the display of the auxiliary graphical data. Consider a case where the auxiliary graphical data D2 is a 2D graphical data (e.g., 2D subtitle). Therefore, the original disparity D of the auxiliary graphical data D2 has a zero disparity value. Please refer to FIG. 8, which is a diagram illustrating the relationship among the original disparity range R_original of the 3D image data D1, the target disparity range R_target, and the original disparity D of the auxiliary graphical data D2. In this example, the aforementioned boundary value V11 is a lower bound of the original disparity range R_original, and the aforementioned boundary value V21 is a lower bound of the target disparity range R_target. As can be seen from FIG. 8, the lower bound V21 of the target disparity range R_target has a negative disparity value. Regarding the original disparity range R_original, it is delimited by the lower bound V11 and an upper bound V12, where the lower bound V11 is lower than the lower bound V21 of the target disparity range R_target. As the 3D image data D1 has original disparity not fully within the target disparity range R_target, the 3D image data D1 is processed by the processing circuit 104 according to the difference DIFF_1 between the boundary values V11 and V21 such that the original disparity range R_original is shifted horizontally right to fall within the target disparity range R_target. That is, all of the disparity values possessed by the original image pair included in the 3D image data D1 should be increased.

FIG. 9 is a diagram illustrating the relationship among the modified disparity range R_mod of the modified 3D image data D1′, the target disparity range R_target, and the modified disparity D′ of the modified auxiliary graphical data D2′. As mentioned above, when a linear mapping scheme is employed by the disparity modification, the size of the modified disparity range R_mod of the modified image pair is equal to the size of the original disparity range R_original of the original image pair. For example, the upper boundary V12′ would be equal to V12+DIFF_1, and the lower bound V11′ would be equal to V11+DIFF_1. However, when a nonlinear mapping scheme is employed by the disparity modification, the size of the modified disparity range R_mod of the modified image pair is different from the size of the original disparity range R_original of the original image pair. For example, the lower bound is equal to V11+DIFF_1, and the upper bound V12′ is different from (e.g., lower than) V12+DIFF_1. It should be noted that aligning the lower bound V11′ of the modified disparity range R_mod with the lower bound V21 of the target disparity range R_target is merely one feasible implementation, and is not meant to be a limitation of the present invention.

Regarding the auxiliary graphical data D2 being a 2D graphical data (e.g., 2D subtitle), the original disparity D is not fully beyond the target disparity range R_target. One exemplary implementation of the disparity modification applied to the auxiliary graphical data D2 is to perform a 2D-to-3D conversion upon the auxiliary graphical data D2 to thereby generate a corresponding 3D graphical data as the modified auxiliary graphical data D2′ with modified disparity D′ outside the target disparity range R_target.

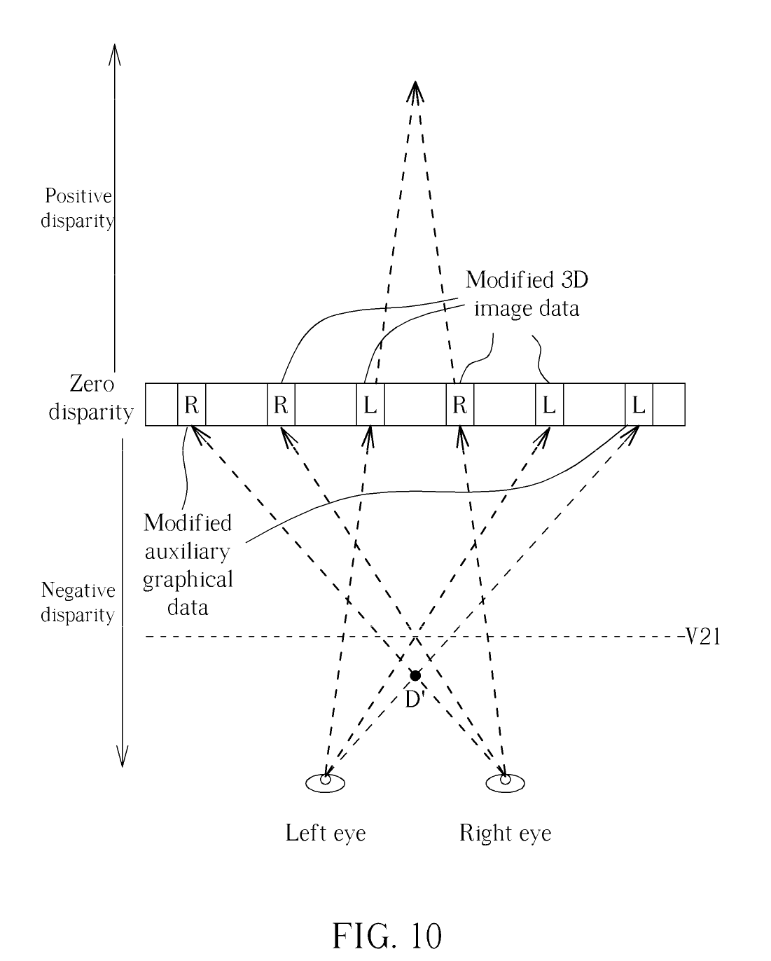

As can be readily seen from FIG. 9, the display of the modified auxiliary graphical data D2′ does not affect the 3D effect provided by the playback of the modified 3D image data D1′ due to the fact that the disparity range of the modified auxiliary graphical data D2′ is not overlapped with the disparity range of the modified 3D image data D1′. Therefore, when the driving circuit 106 drives the display apparatus 101 to display the modified 3D image data D1′ and the modified auxiliary graphical data D2′ with respective disparity settings, the user would always perceive auxiliary graphical data's content displayed in front of 3D image data's content, as shown in FIG. 10.

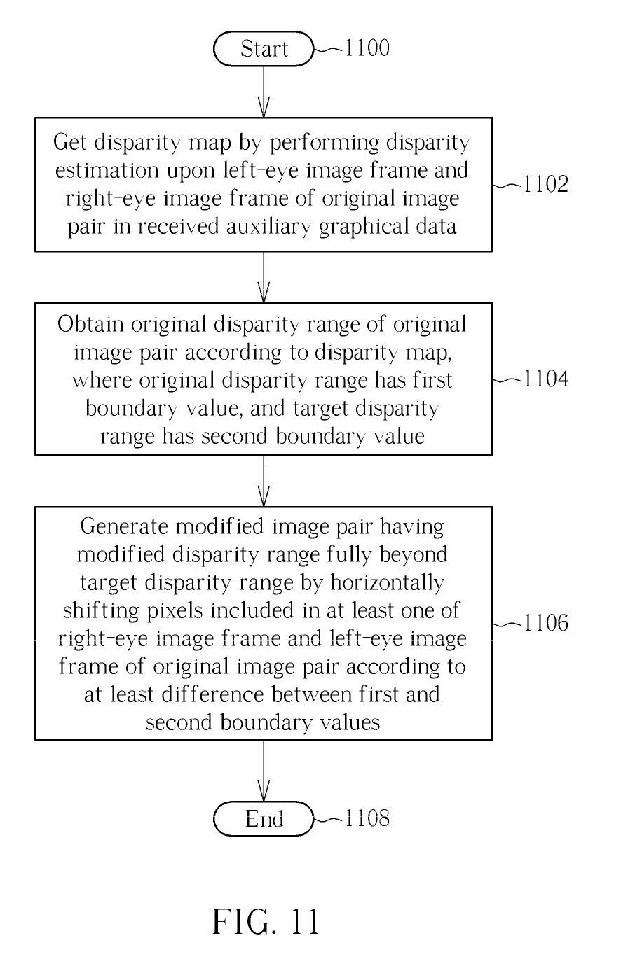

Consider another case where the auxiliary graphical data D2 is a 3D graphical data (e.g., 3D subtitle) with disparity not fully beyond the target disparity range R_target. The disparity modification applied to the 3D graphical data by the processing circuit 104 is illustrated in FIG. 11. FIG. 11 is a flowchart illustrating a method of performing disparity modification upon the auxiliary graphical image data D2 to generate the modified auxiliary graphical data D2′ according to an exemplary embodiment of the present invention. Provided that the result is substantially the same, the steps are not required to be executed in the exact order shown in FIG. 11. Suppose that the received auxiliary graphical data D2 includes at least one image pair each having a right-eye image frame and a left-eye image frame. The disparity modification applied to an original image pair having one right-eye image frame and one left-eye image frame to generate a corresponding modified image pair may include following steps.

Step 1100: Start.

Step 1102: Get a disparity map by performing disparity estimation upon the left-eye image frame and the right-eye image frame of the original image pair in the received auxiliary graphical data D2.

Step 1104: Obtain an original disparity range R_original′ of the original image pair according to the disparity map, where the original disparity range R_original′ has a boundary value V31, and the target disparity range R_target has a boundary value V21.

Step 1106: Generate the modified image pair having a modified disparity range R_mod′ fully beyond the target disparity range R_target by horizontally shifting pixels included in at least one of the right-eye image frame and the left-eye image frame of the original image pair according to at least the difference DIFF_2 between the boundary values V31 and V21.

Step 1108: End.

The disparity modification flow shown in FIG. 11 is similar to the disparity modification flow shown in FIG. 2. As mentioned above, the disparity modification flow shown in FIG. 2 is to make part or all of the modified 3D image data D1′ with modified disparity fully within a target disparity range. However, regarding the disparity modification flow shown in FIG. 11, it is used to make all of the modified auxiliary graphical data D2′ with modified disparity fully beyond a target disparity range. As a person skilled in the art can readily understand details of the disparity modification flow shown in FIG. 11 after reading above paragraphs pertinent to the disparity modification flow shown in FIG. 2, further description is omitted here for brevity.

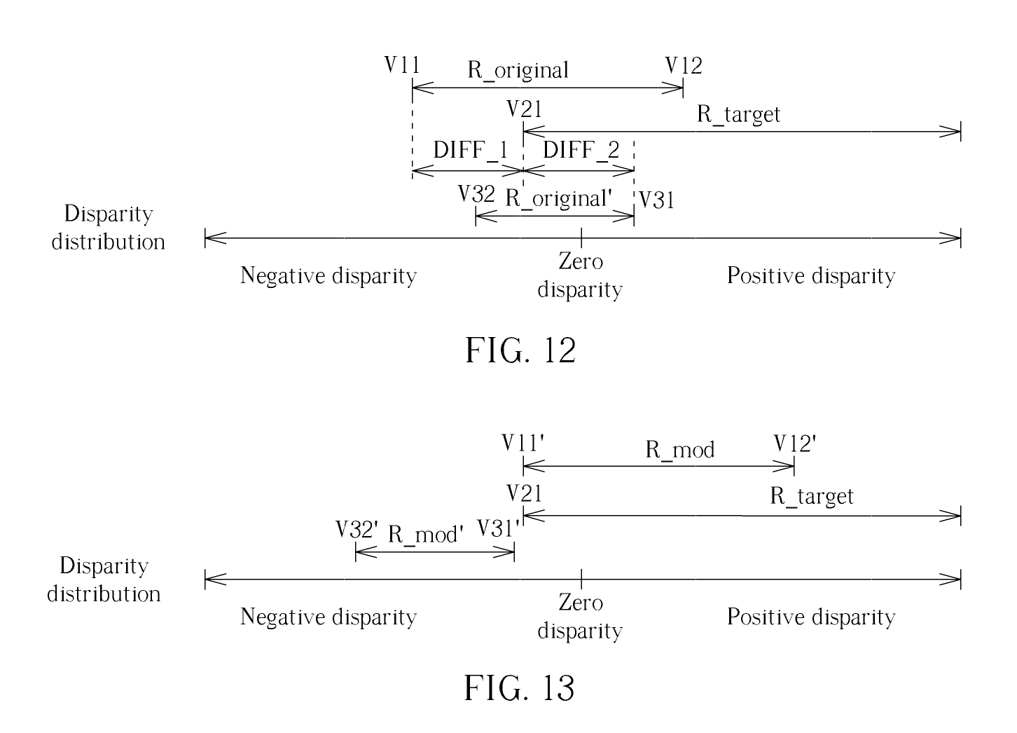

Please refer to FIG. 12, which is a diagram illustrating the relationship among the original disparity range R_original of the 3D image data D1, the target disparity range R_target, and the original disparity range R_original′ of the auxiliary graphical data D2. In this example, the aforementioned boundary value V31 is an upper bound of the original disparity range R_original′, and the aforementioned boundary value V21 is the lower bound of the target disparity range R_target. As can be seen from FIG. 12, the original disparity range R_original′ is delimited by a lower bound V32 and the upper bound V31, where the boundary value V31 is larger than the boundary value V21. The difference DIFF_2 between the boundary values V31 and V21 is referenced for shifting the original disparity range R_original′ horizontally left to be located outside the target disparity range R_target. That is, all of the disparity values possessed by the original image pair in the auxiliary graphical data D2 should be decreased.

One of the linear mapping scheme and the nonlinear mapping scheme may be employed for performing the required disparity modification upon the auxiliary graphical data D2. Please refer to FIG. 13, which is a diagram illustrating the relationship among the modified disparity range R_mod of the modified 3D image data D1′, the target disparity range R_target, and the modified disparity range R_mod′ of the modified auxiliary graphical data D2′. As can be seen from FIG. 13, the modified disparity range R_mod is fully within the target disparity range R_target, while the modified disparity range R_mod′ is fully beyond the target disparity range R_target. Hence, the modified disparity of the modified auxiliary graphical data D2′ is smaller than the modified disparity of the modified 3D image data D1′. The display of the modified graphical data D2′ does not affect the 3D effect provided by the playback for the modified 3D image data D1′ due to the fact that the modified disparity range R_mod is not overlapped with the modified disparity range R_mod′. Similarly, as shown in FIG. 10, the user would always perceive 3D graphical data's content displayed in front of 3D image data's content when the driving circuit 106 drives the display apparatus 101 to display the modified 3D image data D1′ and the modified auxiliary graphical data D2′ with respective disparity settings.

It should be noted that, regarding the second operational scenario, the exemplary disparity modification may be applied to part of the 3D image data rather than all of the 3D image data. As a person skilled in the art can readily understand operation of the exemplary disparity modification applied to part of the 3D image data after reading above paragraphs directed to the exemplary disparity modification applied to all of the 3D image data, further description is omitted here for brevity.

Moreover, the exemplary setting of the target disparity range R_target mentioned above is for illustrative purposes only, and is not meant to be a limitation of the present invention. For example, the lower bound V21 of the target disparity range R_target may be set by a positive disparity value, a zero disparity value, or a negative disparity value, depending upon actual design requirement/consideration.

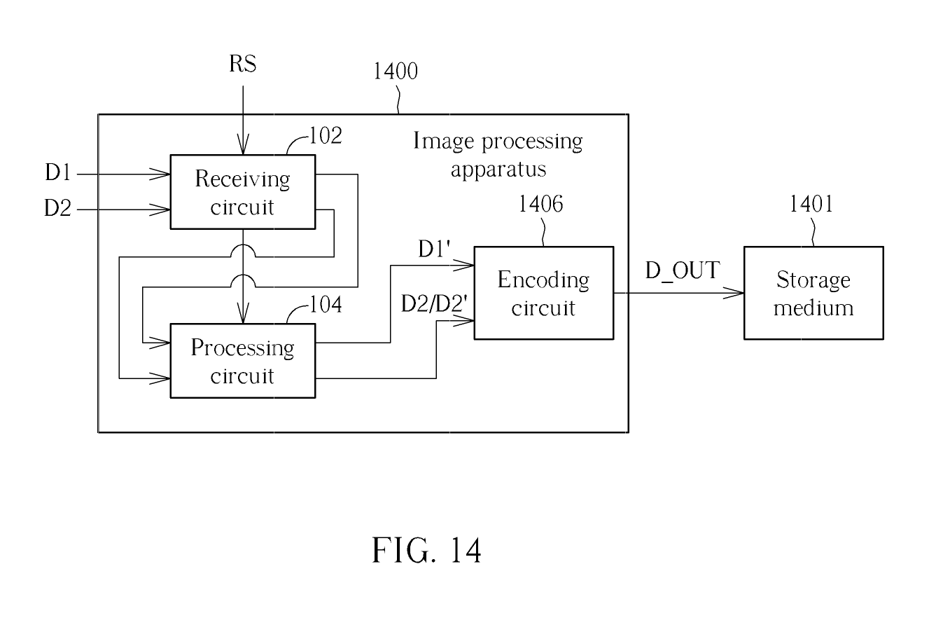

In above exemplary embodiments, the image processing apparatus 100 may be disposed in a video playback apparatus for controlling video/image playback. The output of the processing circuit 104 is therefore transmitted to the driving circuit 106 for driving the display apparatus 101. However, the proposed disparity modification technique may be employed in other applications. FIG. 14 is a block diagram illustrating an image processing apparatus according to a second exemplary embodiment of the present invention. By way of example, but not limitation, the exemplary image processing apparatus 1400 may be disposed in a video encoder for providing video/image data to be displayed. As shown in FIG. 14, the image processing apparatus 1400 includes, but is not limited to, an encoding circuit 1406 and the aforementioned receiving circuit 102 and processing circuit 104. Regarding the first operational scenario where the 3D image data D1 with original disparity not fully within the target disparity range R_target and the auxiliary graphical data D2 with original disparity fully beyond the target disparity range R_target are received by the receiving circuit 102, the encoding circuit 1406 is arranged for generating an encoded data D_OUT to a storage medium (e.g., an optical disc, a hard disk, or a memory device) 1401 by encoding the modified 3D image data D1′ (which may include at least a modified portion obtained from at least a portion of the 3D image data D1 by the disparity modification) and the received auxiliary graphical data D2. Regarding the second operational scenario where the 3D image data D1 with original disparity not fully within the target disparity range R_target and the auxiliary graphical data D2 with original disparity not fully beyond the target disparity range R_target are received by the receiving circuit 102, the encoding circuit 1406 is arranged for generating the encoded data D_OUT to the storage medium 1401 by encoding the modified 3D image data D1′ (which may include at least a modified portion obtained from at least a portion of the 3D image data D1 by the disparity modification) and the modified auxiliary graphical data D2′. As the encoded data D_OUT generated by the source end has the 3D image data separated from the auxiliary graphical data in the disparity domain, no additional disparity modification is required by the playback end. Hence, even though a video player is not equipped with any disparity modification capability, the same objective of preventing the playback of the 3D video data from being obstructed by the display of the auxiliary graphical data is achieved by using the video player to receive the encoded data D_OUT and drive a display apparatus according to the encoded data D_OUT.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, comprising:
receiving a disparity range setting which defines a target disparity range;
receiving a three-dimensional (3D) image data with original disparity not fully within the target disparity range;
receiving an auxiliary graphical data with original disparity fully beyond the target disparity range}; and
generating a modified 3D image data, including at least a modified portion with modified disparity fully within the target disparity range, by modifying at least a portion of the received 3D image data according to the obtained disparity range setting, wherein at least the modified portion of the modified 3D image data is derived from at least the portion of the received 3D image data that has disparity overlapped with disparity of the received auxiliary graphical data.

2. The image processing method of claim 1, further comprising:
driving a display apparatus to display the modified 3D image data and the received auxiliary graphical data.

3. The image processing method of claim 1, further comprising:
encoding the modified 3D image data and the received auxiliary graphical data.

4. The image processing method of claim 1, wherein the original disparity of the auxiliary graphical data is smaller than the modified disparity of at least the modified portion of the modified 3D image data.

5. The method of claim 1, wherein the received 3D image data includes at least one image pair each having a right-eye image frame and a left-eye image frame; and the step of generating the modified 3D image data comprises:
generating a modified image pair having at least a modified portion with a modified disparity range fully within the target disparity range by referring to the obtained disparity range setting to modify an original image pair that is included in the received 3D image data and has at least a portion with an original disparity range not fully within the target disparity range.

6. The image processing method of claim 5, wherein the step of generating the modified image pair comprises:
obtaining the original disparity range of at least the portion of the original image pair, wherein the original disparity range has a first boundary value, and the target disparity range has a second boundary value; and
generating the modified image pair by horizontally shifting pixels included in at least one of a right-eye image frame and a left-eye image frame of at least the portion of the original image pair according to at least a difference between the first boundary value and the second boundary value.

7. The image processing method of claim 6, wherein a size of the modified disparity range of at least the modified portion of the modified image pair is equal to a size of the original disparity range of at least the portion of the original image pair.

8. The image processing method of claim 6, wherein a size of the modified disparity range of at least the modified portion of the modified image pair is different from a size of the original disparity range of at least the portion of the original image pair.

9. An image processing method, comprising:
receiving a disparity range setting which defines a target disparity range;
receiving a three-dimensional (3D) image data with original disparity not fully within the target disparity range;
receiving an auxiliary graphical data with disparity not fully beyond the target disparity range;
generating a modified 3D image data, including at least a modified portion with modified disparity fully within the target disparity range, by modifying at least a portion of the received 3D image data according to the obtained disparity range setting, wherein at least the modified portion of the modified 3D image data is derived from at least the portion of the received 3D image data that has disparity overlapped with disparity of the received auxiliary graphical data; and
generating a modified auxiliary graphical data with modified disparity fully beyond the target disparity range by modifying the received auxiliary graphical data according to the disparity range setting.

10. The image processing method of claim 9, further comprising:
driving a display apparatus to display the modified 3D image data and the modified auxiliary graphical data.

11. The image processing method of claim 9, further comprising:
encoding the modified 3D image data and the modified auxiliary graphical data.

12. The image processing method of claim 9, wherein the modified disparity of the modified auxiliary graphical data is smaller than the modified disparity of at least the modified portion of the modified 3D image data.

13. The method of claim 9, wherein the received 3D image data includes at least one image pair each having a right-eye image frame and a left-eye image frame; and the step of generating the modified 3D image data comprises:
generating a modified image pair having at least a modified portion with a modified disparity range fully within the target disparity range by referring to the obtained disparity range setting to modify an original image pair that is included in the received 3D image data and has at least a portion with an original disparity range not fully within the target disparity range.

14. The image processing method of claim 13, wherein the step of generating the modified image pair comprises:
obtaining the original disparity range of at least the portion of the original image pair, wherein the original disparity range has a first boundary value, and the target disparity range has a second boundary value; and
generating the modified image pair by horizontally shifting pixels included in at least one of a right-eye image frame and a left-eye image frame of at least the portion of the original image pair according to at least a difference between the first boundary value and the second boundary value.

15. The image processing method of claim 14, wherein a size of the modified disparity range of at least the modified portion of the modified image pair is equal to a size of the original disparity range of at least the portion of the original image pair.

16. The image processing method of claim 14, wherein a size of the modified disparity range of at least the modified portion of the modified image pair is different from a size of the original disparity range of at least the portion of the original image pair.

17. The method of claim 9, wherein the received auxiliary graphical data includes at least one image pair each having a right-eye graphical image and a left-eye graphical image; and the step of generating the modified auxiliary graphical data comprises:
generating a modified graphical image pair having a modified disparity range fully beyond the target disparity range by referring to the obtained disparity range setting to modify an original graphical image pair that is included in the received auxiliary graphical data and has an original disparity range not fully beyond the target disparity range.

18. The image processing method of claim 17, wherein the step of generating the modified graphical image pair comprises:
obtaining the original disparity range of the original graphical image pair, wherein the original disparity range has a first boundary value, and the target disparity range has a second boundary value; and
generating the modified graphical image pair by horizontally shifting pixels included in at least one of a right-eye graphical image and a left-eye graphical image of the original graphical image pair according to at least a difference between the first boundary value and the second boundary value.

19. The image processing method of claim 18, wherein a size of the modified disparity range of the modified graphical image pair is equal to a size of the original disparity range of the original graphical image pair.

20. The image processing method of claim 18, wherein a size of the modified disparity range of the modified graphical image pair is different from a size of the original disparity range of the original graphical image pair.

21. An image processing apparatus, comprising:
a receiving circuit, arranged for receiving a disparity range setting which defines a target disparity range, receiving a three-dimensional (3D) image data with original disparity not fully within the target disparity range, and receiving an auxiliary graphical data with original disparity fully beyond the target disparity range; and
a processing circuit, coupled to the receiving circuit and arranged for generating a modified 3D image data, including at least a modified portion with modified disparity fully within the target disparity range, by modifying at least a portion of the received 3D image data according to the obtained disparity range setting, wherein at least the modified portion of the modified 3D image data is derived from at least the portion of the received 3D image data that has disparity overlapped with disparity of the received auxiliary graphical data.

22. The image processing apparatus of claim 21, further comprising:
a driving circuit, coupled to the processing circuit and the receiving circuit, for driving a display apparatus to display the modified 3D image data and the received auxiliary graphical data.

23. The image processing apparatus of claim 21, further comprising:
an encoding circuit, coupled to the processing circuit and the receiving circuit, for encoding the modified 3D image data and the received auxiliary graphical data.

24. The image processing apparatus of claim 21, wherein the original disparity of at least the portion of the auxiliary graphical data is smaller than the modified disparity of at least the modified portion of the modified 3D image data.

25. An image processing apparatus, comprising:
a receiving circuit, arranged for receiving a disparity range setting which defines a target disparity range, receiving a three-dimensional (3D) image data with original disparity not fully within the target disparity range, and receiving an auxiliary graphical data with disparity not fully beyond the target disparity range; and
a processing circuit, coupled to the receiving circuit and arranged for generating a modified 3D image data, including at least a modified portion with modified disparity fully within the target disparity range, by modifying at least a portion of the received 3D image data according to the obtained disparity range setting, and generating a modified auxiliary graphical data with modified disparity fully beyond the target disparity range by modifying the received auxiliary graphical data according to the disparity range setting, wherein at least the modified portion of the modified 3D image data is derived from at least the portion of the received 3D image data that has disparity overlapped with disparity of the received auxiliary graphical data.

26. The image processing method of claim 25, further comprising:
a driving circuit, coupled to the processing circuit and arranged for driving a display apparatus to display the modified 3D image data and the modified auxiliary graphical data.

27. The image processing apparatus of claim 25, further comprising:
an encoding circuit, coupled to the processing circuit and arranged for encoding the modified 3D image data and the modified auxiliary graphical data.

28. The image processing apparatus of claim 25, wherein the modified disparity of at least the portion of the modified auxiliary graphical data is smaller than the modified disparity of at least the modified portion of the modified 3D image data.
